(19) United States
(12) Patent Application Publication
(10) Pub. No.: US 2024/0316559 A1
(43) Pub. Date: Sep. 26, 2024

(54) MICROFLUIDIC DEVICE FOR MANIPULATING A DISCRETE ELEMENT

(71) Applicant: UNIVERSITÉ DE LIÈGE, Liège (BE)

(72) Inventors: Stéphanie VAN LOO, Beaufays (BE); Tristan GILET, Boncelles (BE)

(21) Appl. No.: 18/574,175

(22) PCT Filed: Jul. 15, 2021
(86) PCT No.: PCT/EP2021/069755

§ 371 Date: Dec. 26, 2023

(51) Int. Cl. B01L 3/00

(52) U.S. Cl. CPC B01L 3/502792; B01L 2200/0652; B01L 2300/0645; B01L 2300/0864; B01L 2400/086

(57) ABSTRACT

A microfluidic device for use in field of droplet microfluidics is disclosed. The microfluidic device can manipulate a discrete element, for example a droplet. The discrete element may include a medium and a component. The microfluidic device may include a main microfluidic channel, some stopping elements and an attractive mechanism that may retain, physically and in a releasable way, the component at a given location in the main microfluidic channel. The discrete element may be split into a first and second parts in such a way that the component ends in the second parts. The microfluidic device. may be used especially for a single-cell analysis.

### FIELD OF THE INVENTION

The present invention relates to the implementation, with a microfluidic device, of at least one operation on a discrete element that comprises a medium and a component embedded in the medium.

### BACKGROUND OF THE INVENTION

The handling of a discrete element comprising a medium surrounding a component by a microfluidic device is known. For example, it is known how to use a microfluidic device to handle a microfluidic droplet comprising a liquid surrounding a biological component. When splitting the discrete element into several discrete parts, it might be desirable to know which one of the discrete parts includes the component. An application of such splitting is to capture the secretome of a biological cell in order to analyze it, for example thanks to an immunoassay.

### SUMMARY OF THE INVENTION

An object of the present invention is to provide a microfluidic device able to split a discrete element comprising a medium surrounding a component into several discrete parts, in such a way that the component is in a determined discrete part after the splitting.

In order to fulfill this object, the invention provides for a microfluidic device for manipulating a discrete element, the discrete element comprising a medium and a component surrounded by the medium and having a volume below 500 nanoliters, the microfluidic device comprising a first unit comprising:
a first microfluidic channel having a width below 1 mm and a height below 500 μm,
a first stopping element, a second stopping element, and a third stopping element located successively across the first microfluidic channel, and
an attractive mechanism configured to retain, physically and in a releasable way, the component between the second stopping element and the third stopping element.

The microfluidic device according to the invention may work in the following way. First, the discrete element is blocked between the first and the third stopping elements. Then, the attractive mechanism is used to attract the component between the second and the third stopping elements. Once the component is there, it is retained there by the attractive mechanism while the second stopping element is closed. The closure of the second stopping element divides the discrete element into (i) a first part without the component and located between the first and the second stopping elements, and (ii) a second part with the component and located between the second and the third stopping elements.

The attractive mechanism attracts and retains the component only by means of physical interaction(s), preferably electric (dielectrophoretic for example) and/or magnetic. There is no chemical interaction involved. The attraction and retaining may be stopped, when the attractive mechanism is stopped for example, which sets free the component. The medium is preferably unresponsive to the attraction and the retaining of the attractive mechanism.

In the frame of the present document, a “discrete element” is a volume of material that undergoes operations realized by the microfluidic device. It is physically separated by a background fluid, for example by a gas or a liquid immiscible with the medium, from other discrete elements that may be present at the same time in the microfluidic device. It may be called microcarrier. Its shape adapts to the shape of its container. For example, the discrete element may be a liquid droplet or gel droplet. The volume of the discrete element is preferably below 500 nanoliters. It may be below 5 nanoliters or below 0.5 nanoliters.

In the frame of the present document, a “medium” is a deformable substance, for example gel or liquid. It is preferably an aqueous medium. Because of the background fluid, each discrete element behaves as an individual microreactor that can host an independent assay without significant risk of cross-contamination.

In the frame of the present document, a “component” inside the discrete element may be any type of component: bead, molecule, DNA, RNA, proteins, enzymes, cell, bacteria, virus, etc.

In a possible use of the invention, the medium comprises a biological cell (preferably it comprises a single biological cell) and the component comprises a secretome of said biological cell.

If the medium is an aqueous liquid, the background fluid is preferably a non-polar liquid. If the medium is a hydrogel, the background fluid may be an aqueous liquid.

In the frame of the present document, a “stopping element” is any device able to stop the motion of or to immobilize the discrete element. It may be called “control element”, “trapping element” or “immobilizing element”. It is preferably a valve, more preferably a pneumatic valve, or a dielectrophoretic valve. The stopping element can be based on flow stopping, change of capillary force or heating for example. The stopping elements can be open to let the discrete element move through or it can be closed to stop the discrete element. Preferably, the stopping elements do not affect the background fluid, which is able to move even when they are closed.

In the frame of the present document, an “operation” on a discrete element may be for example any of a loading of a unit, a splitting, a merging, a temporary storage, an unloading from a unit or a combination thereof.

In an embodiment of the invention, the first unit comprises a first electrode between the first and the second stopping elements. The first electrode may be used for merging two discrete elements located on both sides of it by electrocoalescence. Indeed, the background fluid results in a surfactant layer separating both discrete elements and applying an AC voltage on it destabilizes this surfactant layer, thereby inducing their merging.

In an embodiment of the invention, the first unit comprises a recess on a side of the first microfluidic channel and a fourth stopping element between the first microfluidic channel and the recess. The recess may be used to temporarily store a discrete element. The recess may extend in a direction perpendicular to the direction of the first microfluidic channel. The microfluidic device enable the storing of discrete elements, such as the storing of cells, for example for on-chip incubation of cells.

In an embodiment of the invention, the first unit comprises a fifth stopping element located further than the third stopping element across the first microfluidic channel, in such a way that the fifth stopping element delimits an end space of the first microfluidic channel. The third stopping element is thus between the second and the fifth stopping element. The end space can be used to temporarily store a discrete element. The volume of the end space may be at least twice higher than the volume of a discrete element.

In an embodiment of the invention, the attractive mechanism comprises a second and a third electrodes located successively between the second and the third stopping elements. The second electrode may be connected to ground. An AC voltage may be applied to the third electrode in order to attract the component (beads or cells for example) between the second and third electrodes. The non-homogeneous electric field induces a dielectrophoretic force on the component that pulls it to the position of maximum of electric field, i.e. between the second and the third electrodes.

In an embodiment of the invention, the first unit comprises a bypass microfluidic channel forming a bypass of the first microfluidic channel, the first unit comprising a sixth stopping element configured to control a connection between the first port of the first unit and the bypass microfluidic channel.

In an embodiment of the invention, the microfluidic device comprises at least one other unit comprising:
another microfluidic channel having a width below 1 mm and a height below 500 μm,
another first stopping element, another second stopping element, and another third stopping element located successively across the other microfluidic channel, and
a first port.

The at least one other unit consists in a single other unit or in a plurality of others units. The other unit(s) may be identical to the first unit. In each unit, connection between its first port and its microfluidic channel is controlled by its first stopping element. Preferably, each unit comprises only one first port and only one second port. Depending on the way the microfluidic device is used, the second port may be used for the entry of the discrete elements in the unit and the first port for their exit from the unit. The microfluidic device advantageously enables to treat several discrete elements such as for example discrete elements containing cells from different cell populations.

In an embodiment of the invention, the microfluidic device is configured in such way that:
the first stopping element of the first unit and the first stopping element of the at least one other unit are open simultaneously and are closed simultaneously,
the second stopping element of the first unit and the second stopping element of the at least one other unit are open simultaneously and are closed simultaneously, and
the third stopping element of the first unit and the third stopping element of the at least one other unit are open simultaneously and are closed simultaneously.

Some experimental steps can thus be performed in parallel in all units with synchronized stopping elements. The microfluidic device is advantageously programmable, such as with a control unit.

In an embodiment of the invention, the first stopping element of the first unit and the first stopping element of the at least one other unit are controlled by a same first signal network; the second stopping element of the first unit and the second stopping element of the at least one other unit are controlled by a same second signal network; and the third stopping element of the first unit and the third stopping element of the at least one other unit are controlled by a same third signal network.

The signal networks are preferably addressable separately. The signal networks may be called “pneumatic networks”. The signal networks comprise signal lines preferably perpendicular to the first second etc microfluidic channels and parallel to the first, second and third electrodes.

In an embodiment of the invention, the microfluidic device further comprises:
a common connection, a first addressing line configured to open or close a junction between the common connection and the first signal network in such a way that when the junction is open, the pressure in the common connection is communicated to the first signal network,
a second addressing line configured to open or close a junction between the common connection and the second signal network in such a way that when the junction is open, the pressure in the common connection is communicated to the second signal network, and
a third addressing line configured to open or close a junction between the common connection and the third signal network in such a way that when the junction is open, the pressure in the common connection is communicated to the third signal network.

In an embodiment of the invention, the at least one other unit comprises another attractive mechanism configured to retain, physically and in a releasable way, the component between the other second stopping element and the other third stopping element, the microfluidic device being configured in such way that the attractive mechanism of the first unit and the attractive mechanism (30) of the at least one other unit are on simultaneously and are off simultaneously.

Some experimental steps can thus be performed in parallel in all units with synchronized attractive mechanisms. Preferably, the attractive mechanisms comprise the same second electrode and the same third electrode.

In an embodiment of the invention, the at least one other unit comprises a second unit wherein the another microfluidic channel is a second microfluidic channel, the first unit comprising a bypass microfluidic channel forming a bypass of the first microfluidic channel connecting the first port of the first unit and the first port of the second unit, and the first unit comprising a sixth stopping element configured to control a connection between the first port of the first unit and the bypass microfluidic channel.

In an embodiment of the invention, the at least one other unit comprises a third unit, wherein the another microfluidic channel is a third microfluidic channel, the first port of the third unit being fluidically connected to the first port of the first unit at a first bifurcation, the microfluidic device comprising a seventh stopping element controlling whether a discrete element at the first bifurcation moves towards the first port of the first unit or towards the first port of the third unit.

The hydraulic resistance of the pathway between the first bifurcation and the first port of the first unit is preferably lower than the hydraulic resistance of the pathway between the first bifurcation and the first port of the third unit (for example, it may be shorter). Therefore, if the seventh stopping element is in the pathway between the first bifurcation and the first port of the first unit, the discrete element moves towards the first port of the first unit when the seventh stopping element is open.

In an embodiment of the invention, at least one other unit further comprises a fourth unit wherein the another microfluidic channel is a fourth microfluidic channel, the first port of the fourth unit being fluidically connected to the first bifurcation at a second bifurcation, the microfluidic device comprising an eighth stopping element controlling whether a discrete element at the second bifurcation moves towards first bifurcation or towards the first port of the fourth unit.

The hydraulic resistance of the pathway between the second bifurcation and the first bifurcation is preferably lower than the hydraulic resistance of the pathway between the first bifurcation and the first port of the fourth unit (for example, it may be shorter). Therefore, if the eighth stopping element is in the pathway between the second bifurcation and the first bifurcation, the discrete element moves towards the first bifurcation when the eighth stopping element is open.

The invention also relates to a process for manipulating a discrete element with a microfluidic device according to any of the embodiments.

In an embodiment of the invention, the process comprises a loading operation comprising loading the first unit with a first discrete element and loading the at least one other unit with another discrete element. The first discrete element and the other discrete element may be identical or different. The discrete elements are preferably loaded at the same location in the different units. Preferably, all units are loaded with a discrete element. Operations can thus be performed simultaneously on all units.

In an embodiment of the invention, the process comprises a merging operation (201) including the following successive steps:
blocking, with the third stopping element, a first discrete element between the first stopping element and the third stopping element,
blocking, with the first discrete element, a second discrete element, and
applying an electric field between the first discrete element and the second discrete element in order to merge them.

The first discrete element may be in contact with the second electrode and the second discrete element may be in contact with the first electrode, in such a way that the electric field is applied between the first and the second electrodes.

In an embodiment of the invention, the first discrete element comprises at least one cell and the second discrete element comprises a drug. Preferably, the process is performed simultaneously for several drugs in the several units. This increases the experimental throughput for experiments on interactions between cells and drugs.

In an embodiment of the invention, the first discrete element comprises target cell having an antigen on its surface, and the second discrete element comprises an immune cell suitable to produce an antibody suitable to bind to the antigen. The immune cell may be for example plasma cell or Lymphocyte B or Lymphocyte T. The target cell may be for example a tumor cell.

In an embodiment of the invention, the process comprises a selective splitting operation of an initial discrete element comprising a medium and a component surrounded by the medium, the selective splitting operation including the following successive steps:
blocking the initial discrete element with the third stopping element in such a way that it overlaps the second stopping element,
retaining, with the attractive mechanism, physically and in a releasable way, the component between the second stopping element and the third stopping element, and
closing the second stopping element in such a way that the initial discrete element is split into a first part located on one side of the second stopping element and a second part located on the other side of the second stopping element between the second stopping element and the third stopping element, the component being in the second part.

The initial discrete element may be the result of the merging operation of the first discrete element and the second discrete element.

In an embodiment of the invention, the first part is further merged, preferably by a merging operation as described above, with an additional discrete element comprising a reagent. With this process, the content of the first part may react with a further reagent. Their reaction can be observed by imaging, for example if the reagent is marked with a fluorescence marker.

In an embodiment of the invention, the initial discrete element comprises a target cell having an antigen on its surface, an immune cell suitable to produce an antibody suitable to bind to the antigen, and a secretome produced by the target cell and/or the immune cell; after the splitting, the target cell and the immune cell are in the component in the second part and the secretome is in the first part and in the second part; and the reagent is an immunoassay reagent suitable to bind to some molecules of the secretome.

In an embodiment of the invention, the process comprises a splitting operation including the following successive steps:
blocking an initial discrete element with the first stopping element in such a way that it overlaps the second stopping element, and
closing the second stopping element in such a way that an initial discrete element is split into a first part located on one side of the second stopping element, between the first stopping element and the second stopping element, and a second part located on the other side of the second stopping element.

In an embodiment of the invention, the splitting operation comprises, after the initial discrete element is blocked by the first stopping element and before the second stopping element is closed, a step of retaining, with the attractive mechanism, physically and in a releasable way, the component of the initial discrete element between the second stopping element and the third stopping element.

In an embodiment of the invention, the process comprises an imaging and/or tracking of the discrete elements of the microfluidic device. The imaging can for example be done by a camera or a photomultiplier tube. The measurement may include absorbance, reflectance and fluorescence. The microfluidic device enables the tracking of discrete elements, for example the tracking of a cell or the tracking of a secretome of a cell. By tracking is particularly meant temporal tracking or temporal analysis.

In an embodiment of the invention, the process comprises an unloading of the discrete elements from the microfluidic device. They can then be further analyzed by at least one of PCR/sequencing/molecular biology analysis.

In an embodiment of the invention, the discrete element comprises only one biological cell. The microfluidic device according to the invention is especially interesting for single-cell manipulation.

In an embodiment of the invention, the discrete element comprises one only barcode which comprises chains of nucleotides, each chain comprising a first block identifying the chain amongst all chains in the discrete element, a second block identifying the discrete element, and a third block for attachment to a specific nucleotide sequence.

The barcode is part of the component of the discrete element. The barcode may be coupled to a bead, such a gel bead. The second chains of nucleotides are called barcodes since they make possible to identify the bead. The specific nucleotide sequence corresponding to the third block of nucleotides of the chain is generally RNA released by the cell, for example during cell lysis or for cell communication (e.g. the mRNA present in exosomes). Once the bead is coupled to RNA of the cell, the chain and the RNA are sequenced altogether after amplification. The bead barcode indicates from which cell each RNA sequence originates, and the Unique Molecule Identifiers (UMIs) reveal the number of identical RNAs released by the cell.

It is an advantage that the device enables to investigate cell communication.

### BRIEF DESCRIPTION OF THE FIGURES

For a better understanding of the present invention, reference will now be made, by way of example, to the accompanying drawings in which:

FIG. 1 is a cross section of a part of a microfluidic device;

FIG. 2 is a top view of a part of a microfluidic device;

FIG. 3 is a larger top view with respect to FIG. 2;

FIG. 4 illustrates a possible embodiment of a microfluidic device;

FIG. 5 illustrates a possible embodiment of a microfluidic device;

FIG. 6 schematically illustrates a possible embodiment of a microfluidic device;

FIG. 7 illustrates a possible embodiment of a microfluidic device;

FIG. 8 is a top view of a part of a possible embodiment of a microfluidic device;

FIGS. 9a-9f are cross sections of a part of a microfluidic device;

FIGS. 10a-e illustrate a merging operation;

FIGS. 11a-b illustrate a selective splitting operation; and

FIGS. 12a-c illustrate a splitting operation.

### DESCRIPTION OF THE INVENTION

The present invention will be described with respect to particular embodiments and with reference to certain drawings but the invention is not limited thereto. The described functions are not limited by the described structures. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

In the figures, identical or analogous elements may be referred to with the same number.

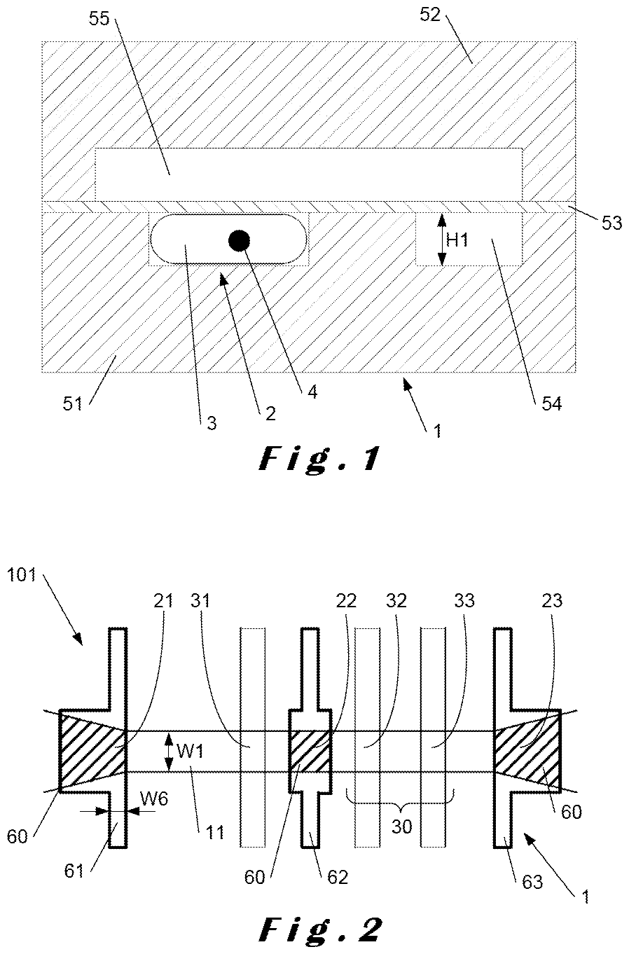

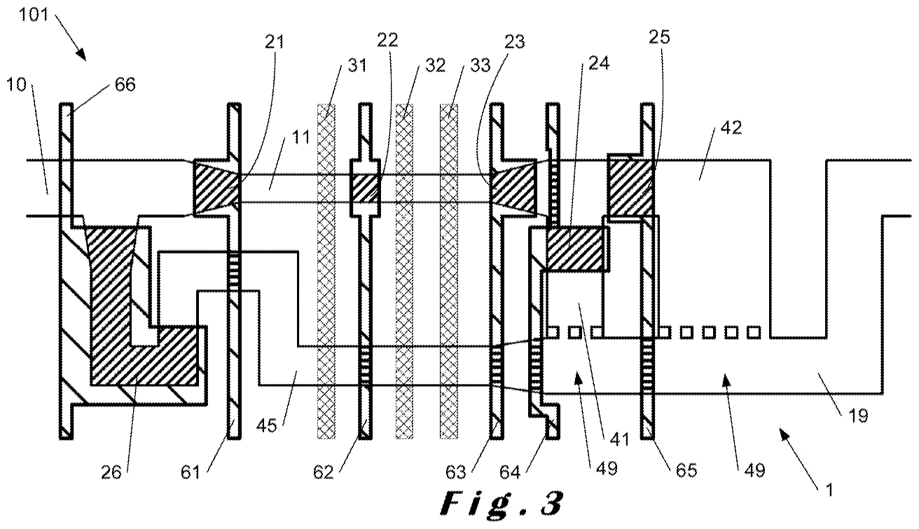

FIG. 1 is a cross section of a part of a microfluidic device 1 for manipulating discrete elements 2 in an embodiment of the invention. The discrete element 2 comprises a medium 3 and a component 4 surrounded by the medium 3. The microfluidic device 1 comprises, successively, a first layer 51, a second layer 52 and an elastic membrane 53. The first layer 51 comprises first cavities 54 in which the discrete elements 2 are located. One of the first cavities 54 forms a first microfluidic channel 11 (FIG. 2) having a height H1. The second layer 52 comprises second cavities 55 wherein a pressure can be applied. It can be called the pneumatic layer. The elastic membrane 53 separates, hermetically, the first 54 and second 55 cavities. Preferably, at least one of the first layer 51 and/or the stack of the second layer 52 and the elastic membrane 53 is transparent, in such a way that the discrete elements 2 are observable through it.

In the frame of the present document a “microfluidic pathway” is any first cavity 54 or collection of first cavities 54 configured to accommodate the discrete elements 2.

When the pressure in a second cavity 55 above a first cavity 54 is above a threshold pressure Pv, the elastic membrane 53 deforms inside the first cavity 54. If deep enough, the deformation of the elastic membrane 53 inside the first cavity 54 forms an obstruction for the discrete elements 2. The depth of the deformation of the elastic membrane 53 depends on the area of the overlap between the first cavity 54 and the second cavity 55: the higher the overlapping area, the deeper the deformation. Therefore, an overlap between a first 54 and a second 55 cavities forms a stopping element only if its area is above a threshold.

In an exemplary embodiment of the invention, the elastic membrane 53 is 7 μm thick and made of polydimethylsiloxane (PDMS), the first 51 and 52 layers are 2 mm thick and made of PDMS, the first 54 and second 55 cavities are 30 μm deep and 100 μm wide, and the threshold pressure Pv is 1 bar.

Preferably, the depth H of the first cavities 54 is constant in the whole microfluidic device. If the microfluidic device is made with the soft lithography technique, H is fixed as the thickness of the spin-coated photoresist. The discrete elements 2 have preferably all the same volume 22. The channel depth is chosen such that πH³/6<Ω, so discrete elements 2 are confined in thickness, i.e. they are squeezed between the bottom wall of the first layer 51 and the elastic membrane 53. In the absence of lateral confinement, the discrete elements 2 take a pancake shape of diameter Wd and thickness is slightly smaller than H. Most first cavities 54 have a width W larger than Wd so discrete elements 2 therein are shaped as pancakes. Some first cavities 54 have a width W<Wd, so discrete elements 2 therein are also confined laterally and they are shaped as plugs: their width Wd is slightly smaller than W while their length Ld is larger than W.

In an embodiment of the invention, Ω=200 pL (picoliter), the height is H=30 μm. For a channel width W=100 μm, the discrete element 2 diameter is approximately Wd=98 μm so discrete elements 2 are shaped as pancakes. For a channel width W<100 μm, discrete elements 2 are shaped as plugs.

FIG. 2 is a top view of a microfluidic device 1 in an embodiment of the invention. The microfluidic device 1 comprises a first unit 101. As will be described later, the microfluidic device 1 may further comprise at least one other unit consisting in a single other unit or in a plurality of others units (second unit 102, third unit 103, fourth unit 104 etc). At least the first unit 101 (and preferably each unit of the at least one other unit) comprises:
a first microfluidic channel 11 (respectively second microfluidic channel 12, third microfluidic channel 13, fourth microfluidic channel 14 etc called other microfluidic channel) having a width (denoted W1 for the first microfluidic channel 1) below 1 mm and a height (denoted H1 for the first microfluidic channel 1, visible at FIG. 1) below 500 μm, preferably below 300 μm,
a first stopping element 21, a second stopping element 22, and a third stopping element 23 (which may be called “other stopping elements” or “stopping elements of the at least one other unit” for the other unit(s)) located successively across the first microfluidic channel 11 (respectively second microfluidic channel 12, third microfluidic channel 13, fourth microfluidic channel 14 etc),
an attractive mechanism 30 (which may be called “other attractive mechanism” or “attractive mechanism of the at least one other unit” for the other unit(s)) configured to retain, physically and in a releasable way, the component 4 between the second stopping element 22 and the third stopping element 23.

Any of the first 11 or other microfluidic channel may be called “main microfluidic channel”.

Each unit 101, 102, 103, 104 etc preferably comprises a first electrode 31 located across the first microfluidic channel 11 (respectively second microfluidic channel 12, third microfluidic channel 13, fourth microfluidic channel 14 etc) between the first 21 and the second 22 stopping elements.

Each attractive mechanism 30 preferably comprises a second 32 and a third 33 electrodes located successively across the first microfluidic channel (respectively second microfluidic channel 12, third microfluidic channel 13, fourth microfluidic channel 14 etc) between the second 22 and the third 23 stopping elements.

The microfluidic device 1 preferably comprises a first signal network 61 controlling all the first stopping elements 21, a second signal network 62 controlling all the second stopping elements 22, and a third signal network 63 controlling all the third stopping elements 23. Each signal network 61, 62, 63 may be formed by channels fluidically connected to be at the same pressure and made of at least one second cavity 55 (FIG. 1). They are filled with a fluid that can be with a reference pressure (atmospheric pressure for example) or with a higher pressure in order to push the elastic membrane 53 in the first cavities. In order to form a stopping element, the second cavity 55 (part of the signal network) increases in width W6 where it overlaps the first cavity 54 (part of the microfluidic pathway) in order to reach the threshold in area mentioned above. Reference 60 indicates such a region of overlap. The first microfluidic channel 11 may increase in width W1 in order to reach the threshold in area.

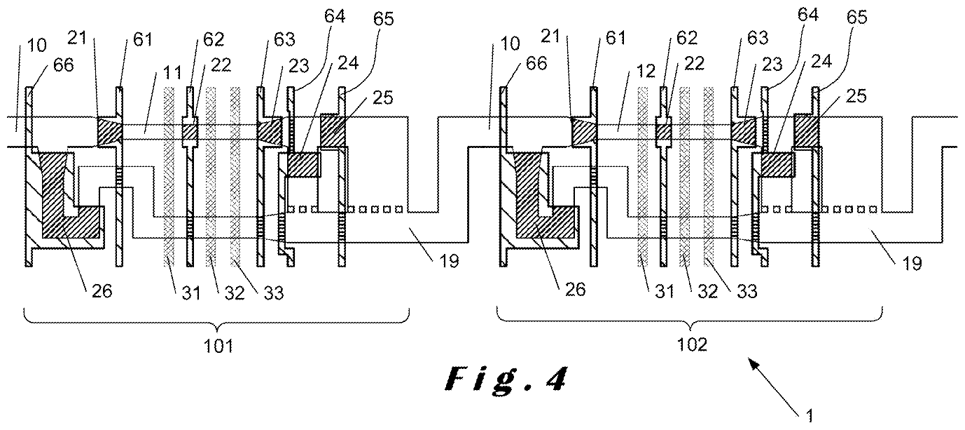

FIG. 3 is a top view of a microfluidic device 1 in an embodiment of the invention. Each unit 101, 102, 103, 104 etc preferably comprises a first port 10 and a second port 19 which are the only accesses for the discrete elements 2. The first microfluidic channel 11 (respectively second microfluidic channel 12, third microfluidic channel 13, fourth microfluidic channel 14 etc) ends with an end space 42. The end space 42 is fluidically connected to the second port 19 by a blocking element 49 that does not stop the background fluid and stops the discrete elements 2. The blocking element 49 may be made of pillars. The spacing between these pillars is significantly smaller than the width Wd of the discrete elements 2. Consequently the discrete elements 2 cannot cross these pillars without being forced to significant shear-induced deformations.

When the pressure is higher at the first port 10 than at the second port 19, the discrete elements 2 move from first port 10 to second port 19 or end space 42. When the pressure is higher at the second port 19 than at the first port 10, the discrete elements 2 move from second port 19 or end space 42 to first port 10.

Each unit 101, 102, 103, 104 etc preferably comprises a recess 41 on a side of the first microfluidic channel 11 (respectively second microfluidic channel 12, third microfluidic channel 13, fourth microfluidic channel 14 etc) accessible to the discrete elements 2 via a fourth stopping element 24. The recess 41 may be connected to the second port 19 by another blocking element 49. Each unit 101, 102, 103, 104 etc preferably comprises a fifth stopping element 25 delimiting the end space 42. The recess 41 preferably opens in the first microfluidic channel 11 (respectively second microfluidic channel 12, third microfluidic channel 13, fourth microfluidic channel 14 etc) between the third 23 and the fifth 25 stopping elements.

Each unit 101, 102, 103, 104 etc preferably comprises a bypass microfluidic channel 45 forming a bypass of the first microfluidic channel 11 (respectively second microfluidic channel 12, third microfluidic channel 13, fourth microfluidic channel 14 etc). The bypass microfluidic channel 45 creates a connection, accessible to the discrete elements 2, between the first port 10 and the second port 19. The first port 10 of the second unit 102 is preferably connected to the bypass microfluidic channel 45 of the first unit 101, via the second port 19 of the first unit 101. Each unit 101, 102, 103, 104 etc preferably comprises a sixth stopping element 26 configured to control a connection between its first port 10 and its bypass microfluidic channel 45.

The fourth (respectively fifth or sixth) stopping elements 24 (respectively 25 or 26) may be controlled by a fourth (respectively fifth or sixth) signal network 64 (respectively 65 or 66). In FIG. 3, the thick oblique hatching indicates that the crossing of the signal network 61-66 and the microfluidic pathway forms a stopping element. Other hatchings (horizontal) indicate that, at this location, the overlap between the signal network and the microfluidic pathway is not sufficient to create a stopping element.

Considering that Wd is the diameter of the discrete elements 2 in the absence of lateral confinement, the width W1 of the first channel 1 between the first 21 and the third 23 stopping elements is smaller than Wd. The distance between the first 21 and the second 22 stopping elements and the distance between the second 22 and the third 23 stopping elements is Wd²/W1 so these zones can host a single droplet of volume 22, preferably in a plug state. The width in front of the first stopping element 21, between the third 23 and the fifth 25 stopping elements and in the recess 41 is preferably higher than Wd, so they can host a single droplet of volume 22 in a pancake state. The dimensions of the end space 42 is preferably at least twice 52 in such a way that it can possibly accommodate a large discrete element made of several discrete elements 2 of volume 2.

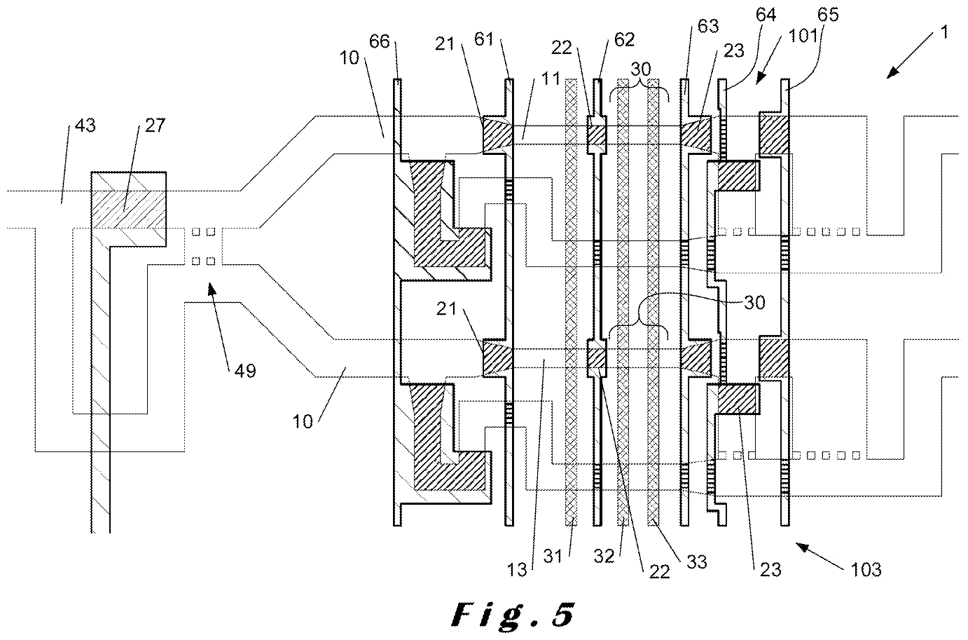

FIG. 4 illustrates a preferred position of the second microfluidic unit 102 with respect to the first microfluidic unit 101. The first port 10 of the second microfluidic unit 102 is preferably in direct fluidic connection with the second port 19 of the first microfluidic unit 101.

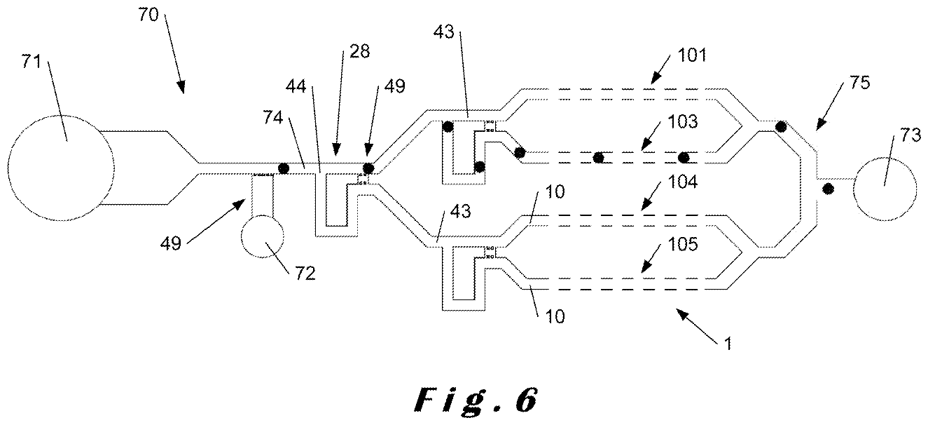

FIG. 5 illustrates a preferred position of the third microfluidic unit 103 with respect to the first microfluidic unit 101. The first port 10 of the third unit 103 is fluidically connected to the first port 10 of the first unit 101 at a first bifurcation 43. A seventh stopping element 27 controls whether a discrete element 2 at the first bifurcation 43 moves towards the first port 10 of the first unit 101 or towards the first port 10 of the third unit 103: when it is open, the discrete element 2 follows the pathway of lower hydraulic resistance towards the first port 10 of the first unit 101, and when it is closed, the discrete element 2 moves towards the first port 10 of the third unit 103. The first electrodes 31 are shared between the first microfluidic unit 101 and the third microfluidic unit 103. The same holds for the second electrodes 32 and the third electrodes 33.

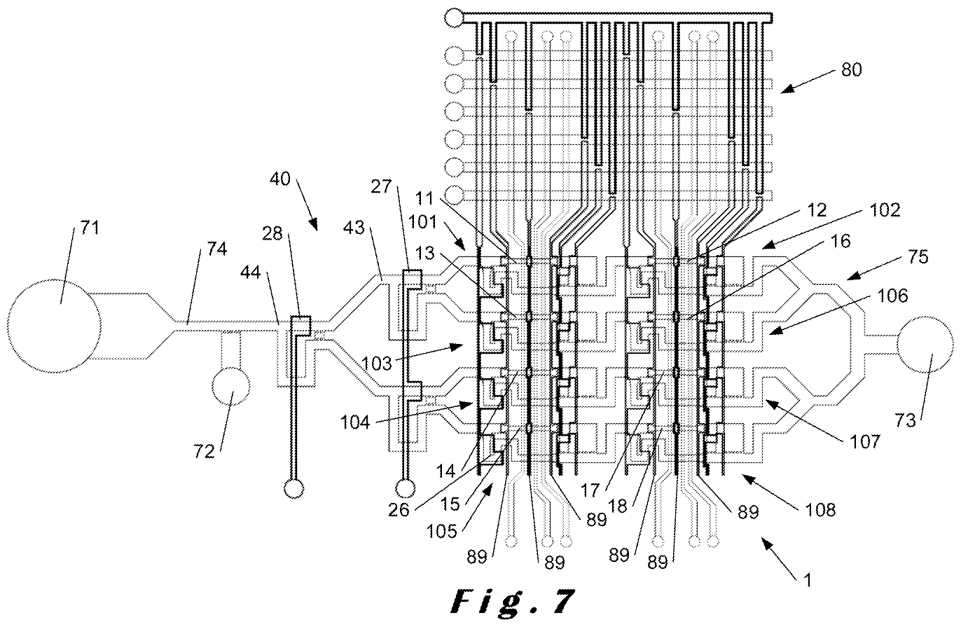

FIG. 6 schematically illustrates a preferred position of the fourth microfluidic unit 104 and a fifth microfluidic unit 105. In FIG. 6, the microfluidic units 101, 103, 104, 105 are schematized with dashed lines. The fifth microfluidic unit 105 is connected to and positioned with respect to the fourth microfluidic unit 104 in the same way the third microfluidic unit 103 is connected to and positioned with respect to the first microfluidic unit 101.

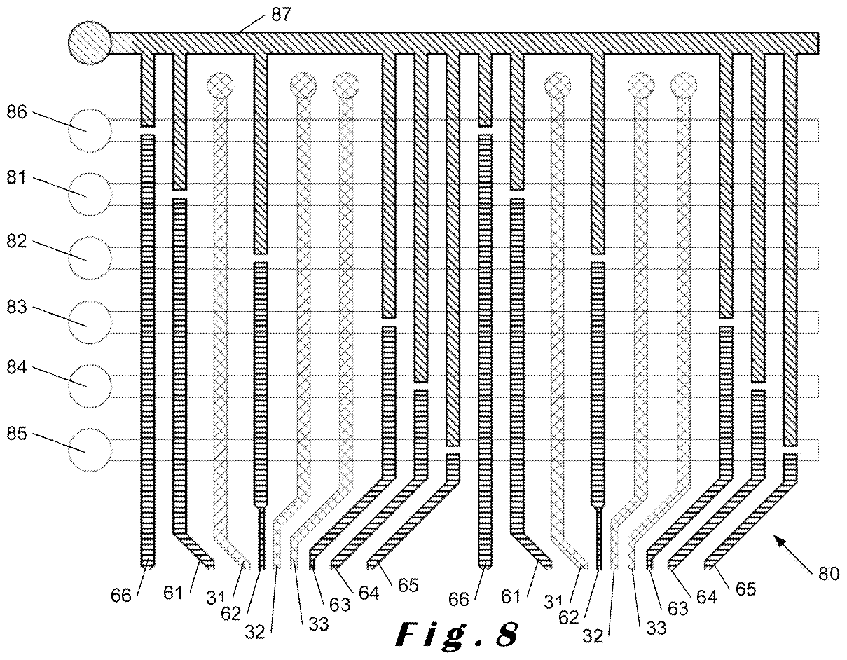

A second bifurcation 44 connects the first bifurcation 43 between the first 101 and third 103 microfluidic units and the first bifurcation 43 between the fourth 104 and fifth 105 microfluidic units. An eighth stopping element 28 (FIG. 6 indicates its position and it is visible at FIG. 7) controls whether a discrete element 2 at the second bifurcation 44 moves towards the first bifurcation 43 between the first 101 and third 103 microfluidic units or towards the first bifurcation 43 between the fourth 104 and fifth 105 microfluidic units.

FIG. 6 also illustrates a fluidic network 70 of the microfluidic device 1 including the microfluidic unit(s) 101, 103, 104, 105 and their surroundings. The fluidic network 70 comprises a first 71, a second 72, and a third 73 access holes.

The fluidic network 70 includes also a general inlet channel 74 connecting the first access hole 71 and the second access hole 72 to the microfluidic unit(s) and a general outlet channel 75 connecting the microfluidic unit(s) to the third access hole 73.

In a first flow configuration, the first access hole 71 and the second access hole 72 are pressurized while the third access hole 73 is at atmospheric pressure, so the first access hole 71 and the second access hole 72 are inlets while the third access hole 73 is an outlet. An emulsion of monodisperse discrete elements 2 in background fluid is injected through the first access hole 71 while additional background fluid is injected through the second access hole 72. The flow from the second access hole 72 is aimed at regulating the spacing between successive discrete elements 2. The discrete elements 2 and intervening background fluid move toward the outlet at the third access hole 73. In a second flow configuration, the third access hole 73 is pressurized while the first access hole 71 and the second access hole 72 are not, so the third access hole 73 is the inlet while the first access hole 71 and the second access hole 72 are the outlets. The background fluid is injected in the third access hole 73. As a result, discrete elements 2 contained in the microfluidic device 1 may be flushed toward the first access hole 71 and the second access hole 72. However, the blocking element 49 in the second access hole 72 channel at the confluence of the first access hole 71 and the second access hole 72 ensure that the discrete elements 2 cannot reach the second access hole 72, so are only sent towards the first access hole 71. Therefore, only the background fluid can flow through the blocking element 49 and reach the second access hole 72 while the emulsion is entirely collected in the first access hole 71.

FIG. 7 is a top view of a microfluidic device 1 in an embodiment of the invention. Even if eight microfluidic units 101-108 are illustrated, any number of microfluidic units can be included in the microfluidic device 1. The microfluidic units 101-108 are preferably configured as an array of NR rows (four rows in the illustrated embodiment) and NC columns (two columns in the illustrated embodiment). The rows are connected in parallel, with the seventh 27 and eighth 28 stopping elements selecting which row receives a discrete element 2 from the general inlet channel 74. In each row, the microfluidic units 101-108 are connected in series, with the sixth stopping element 26 in the upstream microfluidic unit 101, 103, 104, 105 controlling whether the discrete element 2 moves into the main microfluidic channel 11, 13, 14, 15 or into the bypass microfluidic channel 45 in order to move into the downstream microfluidic unit 102, 106, 107, 108 of the corresponding row.

The first bifurcations 43 form a first bifurcation stage and the second bifurcation 44 forms a second bifurcation stage. Altogether, they form a bifurcation tree 40. If the microfluidic device 1 comprises more than four rows, the bifurcation tree 40 preferably comprises additional bifurcation stages.

Each signal network 61-66 preferably comprises a single signal line in each column. Some of the dead ends 89 ending the signal lines of the signal network 61-66 are also visible at FIG. 7. Each electrode 31-33 is preferably common to a full column.

A control unit 80 controls the signals into the signal networks 61-66 and the electrodes 31-33. Each of the signal networks 61-66 may be addressed independently from the other signal networks 61-66. There is preferably one and only one common signal delivered to the signal network 61 in all the units 101-108 at the same time (and similarly for the other signal networks 62-66). Each of the electrodes 31-33 may be addressed independently from the other electrodes 31-33. There is preferably one and only one common electrical potential applied to the electrode 31 in all the units 101-108 at the same time (and similarly for the other signal electrodes 32, 33).

In an embodiment of the invention, the units 101-108 have a size of about 1.58 mm×0.6 mm. Preferably, NR>10 and NC>10. For example, NR=NC=32. With 32 rows, the bifurcation tree 40 comprises five bifurcation stages.

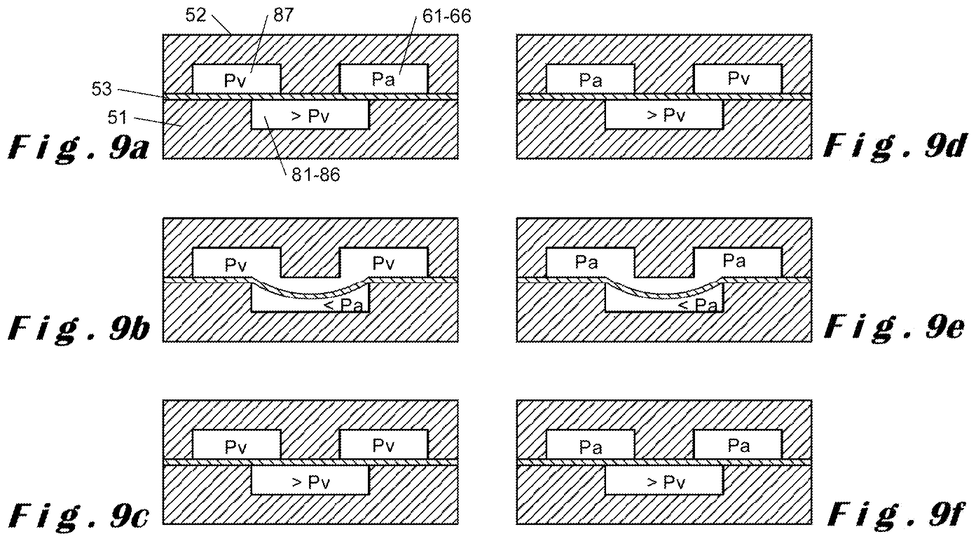

FIG. 8 is a top view of the control unit 80 in the embodiment of the invention shown at FIG. 7. The control unit 80 preferably comprises six addressing lines 81-86, one for each signal networks 61-66, and a common connection 87. Each addressing line 81-86 is configured to open or close a junction between the common connection 87 and its corresponding signal network 61-66. Since the signal lines of the signal network 61-66 end, on the other side of the microfluidic units 101-108, by dead ends 89, when the junction is open, the pressure in the common connection 87 is communicated to every point of the signal lines. The electrodes 31-33 preferably end with a pad configured for an electric connection.

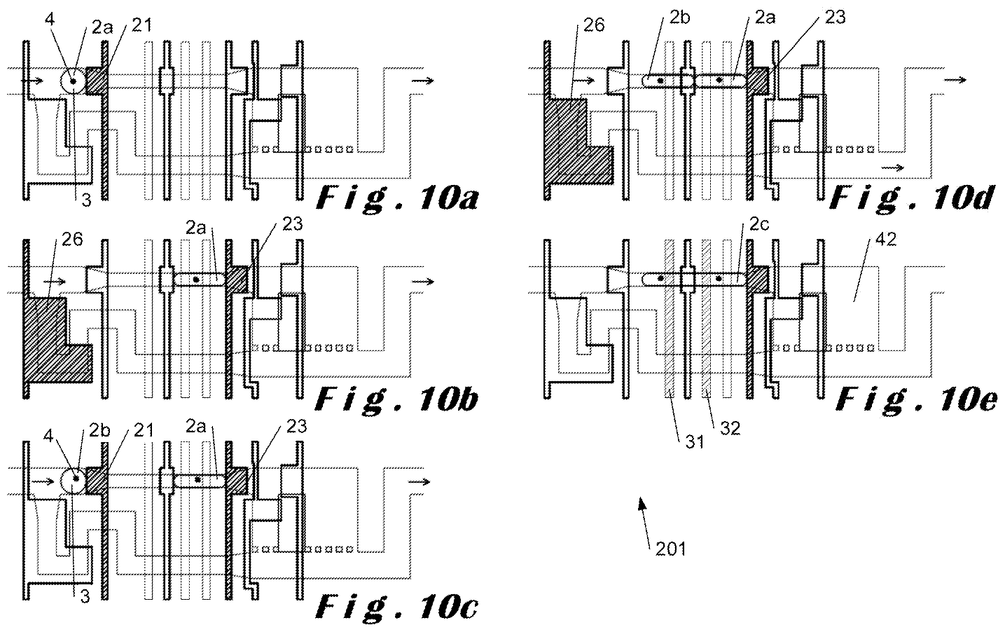

FIG. 9a-9f represent a cross section at one of these junctions. They show the control of the pressure in the signal network 61-66 by the pressure in the addressing lines 81-86 and the common connection 87. Pv is the threshold pressure mentioned above and Pa is a lower pressure (typically the atmospheric pressure). At FIGS. 9a, c, d and f, one of the addressing lines 81-86 is pressurized at a value higher than Pv, the elastic membrane 53 is pushed upward and the corresponding signal network 61-66 remains disconnected from the common connection 87. At FIGS. 9b and e, the addressing line 81-86 is pressurized at a value lower than Pa so elastic membrane 53 is pushed downward, inside the first cavity, and the signal network 61-66 receives the same pressure as the common connection 87 (i.e., Pv at FIG. 9b and Pa at FIG. 9e). During the steps illustrated from FIG. 9b to d, the pressure in the signal network 61-66 is Pv and the corresponding valves are closed. During steps illustrated at FIG. 9a, e and f, the pressure in the signal network 61-66 is Pa and the corresponding valves are open.

Before operating the microfluidic device 1, discrete elements 2 are produced, preferably with a conventional microfluidic junction (e.g., T-junction, flow focusing, cross-junction). This production is preferably done in a separate microfluidic chip. A microfluidic sorter may be placed downstream of the discrete element producer in order to select discrete elements 2 that contain a single bead and/or a single biological cell.

The microfluidic device 1 is especially interesting to perform operations in parallel in several microfluidic units 101-108. Images of the discrete element(s) 2 may be taken at any time, for example to follow an operation or to analyze the content (preferably the component 4) of the discrete element(s) 2.

A preliminary operation comprises the loading of at least some of the microfluidic units 101-108 with discrete elements 2. The loading may be realized for example in the following way for an array of NC columns and NR rows.

An emulsion is injected into the microfluidic device 1 through the first access hole 71 (visible at FIG. 7). The spacing between discrete elements 2 is adjusted thanks to the additional background fluid flow from access hole 72. The discrete elements 2 are then sent to the bifurcation tree 40. The seventh 27 and eighth 28 stopping elements are initially configured to direct the discrete elements 2 towards the first row of the array, which comprises the first 101 and second 102 microfluidic units. At least NC discrete elements 2 are sent to this first row. The seventh 27 and eighth 28 stopping elements are then switched to direct the discrete elements 2 towards the second row of the array. Again, at least NC discrete elements 2 are sent to this second row. The seventh 27 and eighth 28 stopping elements are then switched to direct the discrete elements 2 towards the third row, and so on until discrete elements 2 have been sent to all the rows. The first stopping elements 21 are set in their closed state. A first discrete element 2 arriving into the first unit 101 tries to penetrate the first microfluidic channel 11 but it is stopped by the first stopping element 21. The microfluidic device 1 is configured in such a way that another discrete element 2 arriving into the first unit 101 takes the bypass microfluidic channel 45 and directly moves to the second unit 102, downstream in the first row. For example the location between the first stopping element 21 and the entry of the bypass microfluidic channel 45 may be too small to accommodate two discrete elements 2, which pushes the other discrete element 2 into the bypass microfluidic channel 45. Once in the second unit 102, the other discrete element 2 is blocked by the first stopping element 21. A second other discrete element 2 bypasses the first and second elements before it can be stopped by the first stopping element 21 of a further downstream unit (not illustrated), and so on. If more than NC discrete elements 2 are sent to the first row, discrete elements 2 from NC+1 are not stored in the array and they reach the third access hole 73 where they are discarded. Once the successive configurations of the seventh 27 and eighth 28 stopping elements have led to direct the discrete element 2 stream in each of the NR rows of microfluidic units, the array is filled with NR×NC discrete elements 2 stored in front of the first stopping element 21 of each microfluidic unit. Finally, the stopping elements 21 are opened and each stored discrete element 2 may progress through the corresponding main microfluidic channel.

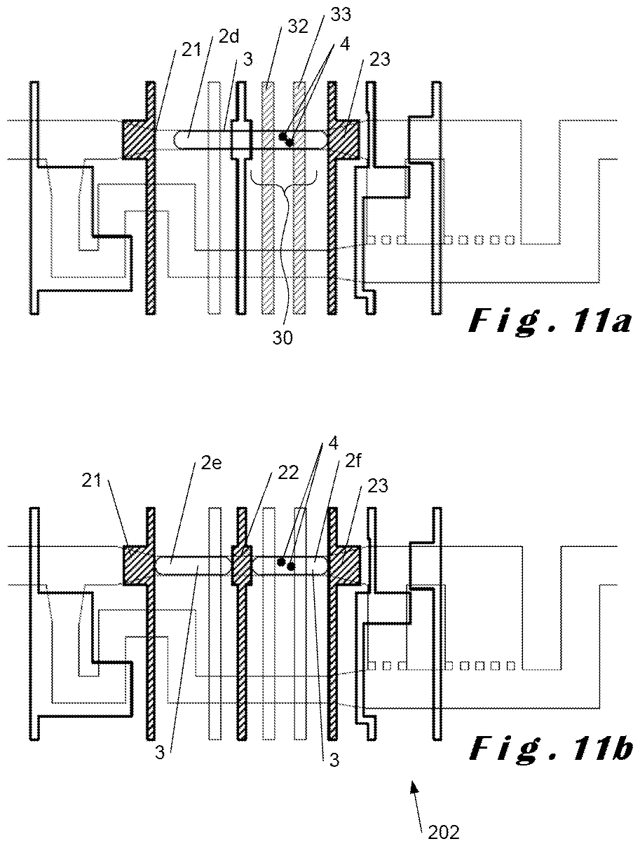

FIGS. 10a-e illustrate steps of an operation of merging 201 of a first discrete element 2a (from a first population of discrete elements for example) with a second discrete element 2b (from a second population of discrete elements for example), performed simultaneously in several of the units 101-108. In the discrete elements 2a, 2b, the white surface represents the medium 3 and the black dot represents the component 4. First, the first discrete elements 2 are loaded in front of the first stopping elements 21 as described above (FIG. 10a). The third 23 and sixth 26 stopping elements are then closed at the same time as the opening of first stopping elements 21. Consequently, the first discrete elements 2 move until they reach the third stopping elements 23 (FIG. 10b). Once the first discrete elements 2 are stored in front of the third stopping elements 23, the second discrete elements 2 are loaded in front of the first stopping elements 21 thanks to the closing of first stopping elements 21. (FIG. 10c). The sixth 26 stopping elements are then closed at the same time as the opening of first stopping elements 21. Consequently, the second discrete elements 2 move forward in the main channel and are blocked by the second discrete elements 2 (FIG. 10d). Electrodes 31 are then switched on and electrodes 32 are at ground, which induces the merging of both discrete elements 2 through electrocoalescence (FIG. 10e). The resulting discrete elements 2c, of volume 252, may be stored into the large end space 42 through an opening of the third 23 and fifth 25 stopping elements. Alternatively, they may remain between the first 21 and third 23 stopping elements for further processing.

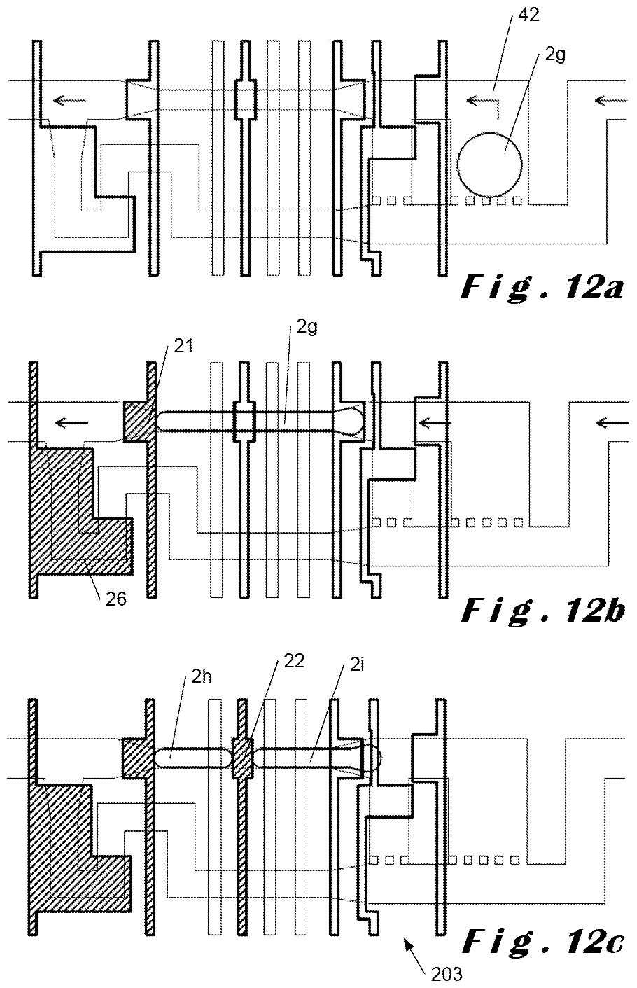

FIGS. 11a-b illustrate steps of an operation of selective splitting 202 of an initial discrete element 2d, for example of volume 262, into a first part 2e and a second part 2f. The first part 2e and the second part 2f are discrete elements, preferably of the same volume 22. First, the initial discrete element 2d is blocked by the third stopping element 23 in such a way that it overlaps the second stopping element 22 (FIG. 11a). If it is not the case, access holes may be pressurized and the sixth stopping element 26 may be closed to drive the initial discrete element 2d there; the first 21 and third 23 stopping elements are then closed to trap the initial discrete element 2d and the pressure at access holes can be switched off. The attractive mechanism 30 is then activated to attract and retain, physically and in a releasable way, the component 4 between the second stopping element 22 and the third stopping element 23. For example, the third electrode 33 may be activated and the second electrode 32 may be at ground. The amplitude and frequency of the voltage in the third electrode 33 are preferably configured to create a dielectrophoretic migration of the component 4 in the initial discrete element 2d towards the position of maximum electric field, i.e. in between the second 32 and the third 33 electrodes. This makes possible to control in which of the first 2e and second 2f parts the component 4 is located. Then, the second stopping element 22 is closed, which splits the initial discrete element 2d in the first 2e and second 2f parts (FIG. 11b). The component 4 is in the second part 2f, between the second 22 and the third 23 stopping elements.

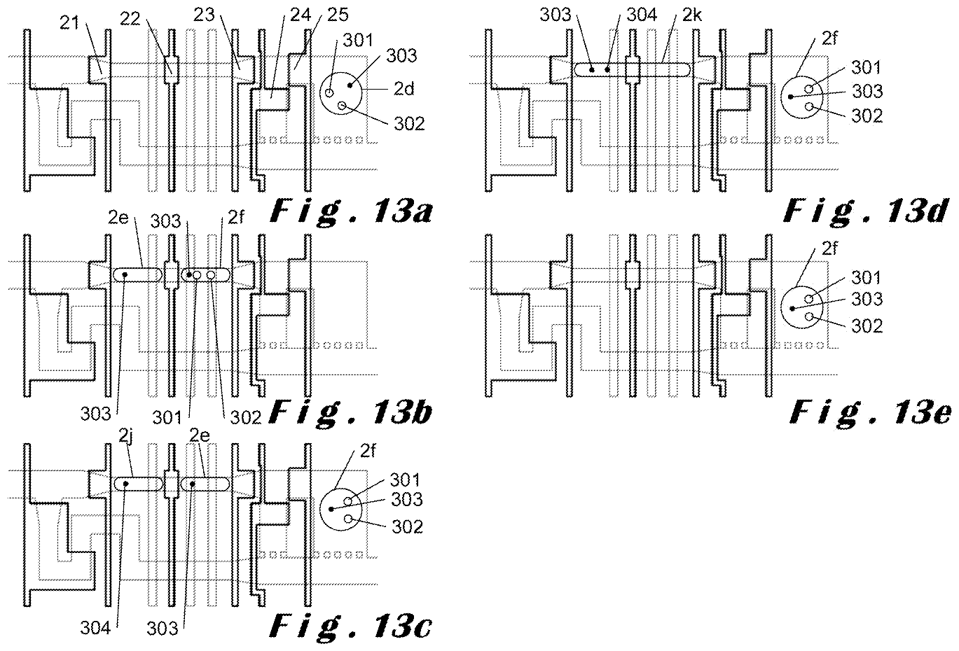

FIGS. 12a-c illustrate steps of an operation of splitting 203 of an initial discrete element 2g, for example of volume nΩ (n>2), into a first part 2h and a second part 2i. The first part 2h may have a volume 22 and the second part 2i a volume (n−1) 22. The initial discrete element 2g may for example be initially in the end space 42 (FIG. 12a). The third access hole 73 is pressurized to create a flow from it towards the first access hole 71 and the sixth stopping element 26 is closed in order to initiate some flow from the end space 42 to the first port 10 in the processing zone and subsequently push the initial discrete element 2g against the first stopping element 21 (FIG. 12b). Then the second stopping element 22 is closed which splits the initial discrete element 2g in the first 2h and the second 2i parts (FIG. 12c). Before closing the second stopping element 22, the attractive mechanism 30 may be activated to attract and retain, physically and in a releasable way, the component 4 in the second part 2i.

For an operation of temporary storage, the discrete element 2 may be placed in the recess 41 (visible in FIG. 3) while the fourth stopping element 24 is closed, or in the end space 42 while the fifth stopping element 25 is closed. Other operations can be performed on other discrete elements 2 during that time.

For an operation of unloading of the discrete elements 2, a pressure is applied at the third access hole 73, while, first, the first and sixth stopping elements 21 and 26 are closed (so the stored discrete elements 2 move right behind the first stopping element 21), and second, the first and sixth stopping elements 21 and 26 are open (so the discrete elements 2 can flow toward the first access hole 71). The discrete elements 2 are collected at the first access hole 71.

An order of magnitude of the hydraulic resistance may be obtained by considering single-phase Poiseuille flows with an equivalent viscosity of 5 cP (the additional resistance induced by the discrete elements 2 is here neglected). The estimated resistance of one unit is of the order of 37 Pa·s/nL for a width of 100 μm, a height of 30 μm and a microfluidic unit 101-108 of equivalent length of 2.8 mm. Since units on the same row are connected in series and units of different rows are connected in parallel, and if NR=NC, the array offers the same equivalent resistance as one unit. The resistance of the bifurcation tree is estimated to 71 Pa·s/nL, so the total resistance of the network in the discrete element 2 layer is of the order of 110 Pa·s/nL. If a pressure difference of 1 bar is applied between the discrete element 2 first port and second port, the pressure difference across one unit will be of the order of 11 mbar if NR=NC=32. The difference of Laplace pressure that needs to be counterbalanced in order to push discrete elements 2 in the convergent channels of the units is of the order of 4 mbar for a width of 100 μm, so the considered pressure difference is sufficient. The resulting characteristic speed in the processing zone of each unit is of the order of 5 mm/s, so each unit is crossed in about 0.5 s and a discrete element 2 would take less than 20 s to travel from one extremity of a row of units to the other. If successive discrete elements 2 are spaced by 1 mm, then the array may be supplied with a new population of discrete elements 2 in a time of the order of 5 minutes.

An AC voltage of 50 V between the second 32 and third 33 electrodes would generate an electric field of the order of 0.5 V/μm if the distance between the second 32 and third 33 electrodes is 100 μm, which is largely below the limit of dielectric breakdown. The corresponding dielectrophoretic velocity is proportional to the square of the hydrodynamic radius of the particle. This velocity would be of the order of 1 mm/s for components 4 of radius 5 μm (Clausius-Mossotti factor assumed to be approximately 0.5). By contrast, the size of macromolecules is in the range of a few nanometers so their dielectrophoretic velocity is of the order of 1 nm/s. The dielectrophoretic drift of macromolecules is therefore largely overcome by their molecular diffusion: their concentration remains homogeneous up to the centimeter scale.

The microfluidic device 1 may be used for applications involving biological cells (or macromolecules or particles) at the scale of one (single-cell), several biological cells (1 to 10, 1 to 100), or even large amount of biological cells such as spheroids and organoids (e.g. 100 to 10000 cells).

Examples of applications are:
interaction screening such as interaction between single-cells or interaction between single-cells and multiple cells or spheroids or organoids, also such as interaction between two or more multiple cells or spheroids or organoids;
host-pathogen interaction such as between target cells and bacteria or viruses;
antagonistic interactions between cell types such as immune cells with cancer cells, which can be used as a model for immuno-therapy;
measurement of drug toxicity along time such as by pairing of discrete elements 2 containing target cells with discrete elements 2 containing a drug in various concentrations;
3D organization of spheroids/organoids. This can be studied for example after the pairing of two or more spheroids (one in a different discrete element 2) formed from different types of cells by screening of the organization of the different cell types in the 3D structure (e.g. core-shell structure or side-by-side);
study of various growth media and observation of the secretion along time thanks to an immunoassay in discrete elements 2 or a mortality assay using a stain, the latter enabling to distinguish death/live cells.

### First Example of Application: Single-Cell Interaction Screening

This example concerns the screening of the secretome of immune cells (e.g. plasma cells or Lymphocyte B or Lymphocyte T, . . . ) in presence of target cells presenting antigens on their surface (e.g. tumor cells). The immune cell produces antibodies suitable to bind to the antigens of the target cells. Many details provided in the description of this example are not compulsory for a general application of the process.

The immune cells and the target cells are stained with a fluorescence membrane marker that will allow their detection in the discrete elements.

The immune cells are individually encapsulated in aqueous-in-oil discrete elements, for example on a chip with flow focusing junction, T-junction, cross-junction, or any other geometry allowing single-cell encapsulation.

The discrete elements presumably containing the immune cells are sorted thanks to the fluorescence membrane marker, and the empty discrete elements and discrete elements containing more than one cell are discarded. The sorting can be performed thanks to valves, e.g. dielectrophoretic or pneumatic valves.

The discrete elements are loaded in units 101-108 of the microfluidic device 1, with maximum one discrete element per unit 101-108. The situation corresponds to FIG. 10b, the discrete element with the immune cell being the first discrete element 2a and the immune cell being its content 4.

The target cells are individually encapsulated in aqueous-in-oil discrete elements, for example on a chip with flow focusing junction, T-junction, cross-junction, or any other geometry allowing single-cell encapsulation.

The discrete elements presumably containing the target cells are sorted thanks to the fluorescence membrane marker, and the empty discrete elements and discrete elements containing more than one cell are discarded. The sorting can be performed thanks to valves, e.g. dielectrophoretic or pneumatic valves.

The discrete elements are loaded in units 101-108 of the microfluidic device 1, with maximum one discrete element per unit 101-108. The situation corresponds to FIG. 10c, the discrete element with the target cell being the second discrete element 2b and the target cell being its content 4.

The discrete element with the immune cell 2a is then merged with the discrete element with the target cell 2b as illustrated on FIG. 10d, 10e. At this point, immune cells and target cells start to interact with each other. The resulting discrete element may be placed in the end space 42. In this example, the secretome (e.g. antibodies, cytokines, interferons, . . . ) produced by the single immune cell and/or the single target cell in the merged discrete element is analyzed at least once and preferably regularly. The analysis can be performed for example with an immunoassay, as described hereby referring to FIGS. 13a-13e.

The discrete element resulting from the merging is referred to as the initial discrete element 2d since it will be split as described with reference to FIGS. 11a-11b. It comprises the target cell 301, the immune cell 302, and the secretome 303 produced by the target cell 301 and/or the immune cell 302.

At FIG. 13a, the initial discrete element 2d is in the end space 42.

At FIG. 13b, the initial discrete element 2d is split into a first part 2e and a second part 2f (as described with reference to FIGS. 11a-11b). The cells 301 and 302 are in the second part 2f since they were attracted and maintained between the second 22 and the third 23 stopping elements by the attractive mechanism 30. The secretome 303 is distributed in both first part 2e and second part 2f.

Between FIGS. 13b and 13c, the first access hole 71 is pressurized to induce a flow from the first access hole 71 to the third access hole 73, and the stopping element 25 is opened to bring the second part 2f in the end space 42, while keeping the stopping element 22 closed to keep first part 2e in place. Then stopping element 23 is closed and stopping element 22 is opened, so the first part 2e can move in front of 23.

At FIG. 13c, an additional discrete element 2j comprising a reagent 304 is loaded in the unit (preferably in all units in parallel). The reagent 304 is an immunoassay reagent suitable to bind to the secretome 303.

At FIG. 13d, the additional discrete element 2j is merged with the first part 2e (as illustrated on FIG. 10d, 10e), preferably by applying an electric field between the first electrode 31 and the second electrode 32. The merged discrete element 2k may remain in place for incubation (if it takes less than 15 minutes for example) or be placed in the recess 41 for long period incubation (more than several hours, such as 24 or to 48 hours). The microfluidic device 1 may be observed (once or regularly) with a fluorescence detector (XY stage move for example), in order to detect the merged discrete elements 2k with positive immunoassay reaction.

At FIG. 13e, the merged discrete element 2k has been collected. It may be analyzed further outside the microfluidic device 1. The discrete element 2f that contains the cells 301, 302 (second part 2f after the split) may remain there for further analysis. The discrete elements 2f that contains the cells 301, 302 in units where a positive immunoassay reaction was observed may be collected for further analysis (molecular biology, sequencing, PCR, MS, . . . ) outside the microfluidic device 1, preferably thanks to a genetic barcode embedded in the discrete element 2f.

### Second Example of Application: Temporal Analysis of Cytotoxicity Caused by a Drug

Such an analysis can be used to screen single cells/multiple cells/organoids with various drug concentrations. The following steps will be followed: firstly, encapsulate the cells (single or multiple) in first discrete elements 2a and load them into the microfluidic device 1 as described above in the merging operation 201. Secondly, encapsulate the drug at the various concentrations in second discrete elements 2b. Thirdly perform the pairing by loading the microfluidic device 1 with second discrete elements 2b as described above in the merging operation 201. Fourthly perform the merging of the pairs as described above in the merging operation 201. Lastly perform several times an analysis by imaging the 3D structure of the spheroids with single-cell resolution.

Third example of application: screening of drug dose response on spheroids from precious samples (solid tumor, stem cells, . . . )

Firstly, encapsulate cells at high concentration (>5.10\hat{ }6 cells/mL) in discrete elements 2 containing hundreds to thousands of cells. Possibly, encapsulate in smaller discrete elements 2 with lower amount of cells (tens to hundreds). Secondly, load the discrete elements 2 in the microfluidic device 1. Thirdly, merge several discrete elements 2 to form larger discrete elements 2 with the desired amount of cells. Then let the cells sediment for several hours to form a spheroid. Culture the spheroids as long as needed (24h to several days). At any time or every hour, bring new discrete elements 2 with fresh culture medium to each spheroid discrete elements 2 to refresh the medium (nutrients & gas).

Lastly, at any time, perform an analysis on the spheroid such as an immunoassay in droplets, a visual inspection, or a collection of spheroids off-chip for PCR/sequencing/molecular biology analysis.

In other words, the invention relates to the field of droplet microfluidics. It concerns a microfluidic device 1 for manipulating a discrete element 2, for example a droplet. The discrete element 2 comprises a medium 3 and a component 4. The microfluidic device 1 comprises a main microfluidic channel 11, some stopping elements 21, 22, 23 and an attractive mechanism 30 configured to retain, physically and in a releasable way, the component 4 at a given location in the main microfluidic channel 11. The discrete element 2 may be split into a first and second parts in such a way that the component 4 ends in the second parts. The microfluidic device 1 may be used especially for a single-cell analysis.

Although the present invention has been described above with respect to particular embodiments, it will readily be appreciated that other embodiments are also possible.

1. Microfluidic device for manipulating a discrete element, the discrete element comprising a medium and a component surrounded by the medium and having a volume below 500 nanoliters, the microfluidic device comprising a first unit comprising:
a first microfluidic channel having a width below 1 mm and a height below 500 μm,
a first stopping element, a second stopping element, and a third stopping element located successively across the first microfluidic channel, and
an attractive mechanism configured to retain, physically and in a releasable way, the component between the second stopping element and the third stopping element.

2. The microfluidic device according to claim 1, wherein the first unit comprises a first electrode between the first and the second stopping elements.

3. The microfluidic device according to claim 1, wherein the first unit comprises a recess on a side of the first microfluidic channel and a fourth stopping element between the first microfluidic channel and the recess.

4. The microfluidic device according to claim 1, wherein the first unit comprises a fifth stopping element located further than the third stopping element across the first microfluidic channel, in such a way that the fifth stopping element delimits an end space of the first microfluidic channel.

5. The microfluidic device according to claim 1, wherein the attractive mechanism comprises a second and a third electrodes located successively between the second and the third stopping elements.

6. The microfluidic device according to claim 1, wherein the first unit comprises a bypass microfluidic channel forming a bypass of the first microfluidic channel, the first unit comprising a sixth stopping element configured to control a connection between a first port of the first unit and the bypass microfluidic channel.

7. The microfluidic device according to claim 1, comprising at least one other unit comprising:
a different microfluidic channel having a width below 1 mm and a height below 500 μm;
another first stopping element, another second stopping element, and another third stopping element located successively across the first microfluidic channel; and
a first port.

8. The microfluidic device according to claim 7:
wherein the first stopping element of the first unit and the first stopping element of the at least one other unit are open simultaneously and are closed simultaneously;
wherein the second stopping element of the first unit and the second stopping element of the at least one other unit are open simultaneously and are closed simultaneously; and
wherein the third stopping element of the first unit and the third stopping element of the at least one other unit are open simultaneously and are closed simultaneously.

9. The microfluidic device according to claim 8, wherein the first stopping element of the first unit and the first stopping element of the at least one other unit are controlled by a first signal network; the second stopping element of the first unit and the second stopping element of the at least one other unit are controlled by a same second signal network; and the third stopping element of the first unit and the third stopping element of the at least one other unit are controlled by a same third signal network.

10. The microfluidic device according to claim 9, further comprising:
a common connection, a first addressing line configured to open or close a junction between the common connection and the first signal network in such a way that when the junction is open, a pressure in the common connection is communicated to the first signal network;
a second addressing line configured to open or close a junction between the common connection and the second signal network in such a way that when the junction is open, the pressure in the common connection is communicated to the second signal network; and
a third addressing line configured to open or close a junction between the common connection and the third signal network in such a way that when the junction is open, the pressure in the common connection is communicated to the third signal network.

11. The microfluidic device according to claim 7, wherein the at least one other unit comprises another attractive mechanism configured to retain, physically and in a releasable way, the component between the other second stopping element and the other third stopping element, the microfluidic device being configured in such way that the attractive mechanism of the first unit and the attractive mechanism of the at least one other unit are on simultaneously and are off simultaneously.

12. The microfluidic device according to claim 7, wherein the at least one other unit comprises a second unit wherein the different microfluidic channel is a second microfluidic channel, wherein the first unit comprises a bypass microfluidic channel forming a bypass of the first microfluidic channel connecting the first port of the first unit and the first port of the second unit, and wherein the first unit further comprises a sixth stopping element configured to control a connection between the first port of the first unit and the bypass microfluidic channel.

13. The microfluidic device according to claim 7, wherein the at least one other unit comprises a third unit, wherein the different microfluidic channel is a third microfluidic channel, wherein the first port of the third unit being is fluidically connected to the first port of the first unit at a first bifurcation, and wherein the microfluidic device comprises a seventh stopping element controlling whether a discrete element at the first bifurcation moves towards the first port of the first unit or towards the first port of the third unit.

14. The microfluidic device according to claim 13, wherein the at least one other unit further comprises a fourth unit wherein the different microfluidic channel is a fourth microfluidic channel, wherein the first port of the fourth unit being is fluidically connected to the first bifurcation at a second bifurcation, and wherein the microfluidic device comprises an eighth stopping element controlling whether a discrete element at the second bifurcation moves towards first bifurcation or towards the first port of the fourth unit.

15. A process for manipulating a discrete element with the microfluidic device according to claim 1.

16. The process according to claim 15, further comprising a loading operation comprising loading the first unit with a first discrete element and loading the at least one other unit with a different discrete element.

17. The process according to claim 15, comprising a merging operation:
blocking, with the third stopping element, a first discrete element between the first stopping element and the third stopping element;
blocking, with the first discrete element, a second discrete element; and
applying an electric field between the first discrete element and the second discrete element in order to merge them.

18. The process according to claim 17, wherein the first discrete element comprises at least one cell and the second discrete element comprises a drug.

19. The process according to the claim 17, wherein the first discrete element comprises target cell having an antigen on its surface, and the second discrete element comprises an immune cell suitable to produce an antibody suitable to bind to the antigen.

20. The process according to claim 15, comprising a selective splitting operation of an initial discrete element comprising a medium and a component surrounded by the medium, wherein the selective splitting operation including the following steps:
blocking the initial discrete element with the third stopping element in such a way that it overlaps the second stopping element;
retaining, with the attractive mechanism, physically and in a releasable way, the component between the second stopping element and the third stopping element; and
closing the second stopping element in such a way that the initial discrete element is split into a first part located on one side of the second stopping element and a second part located on the other side of the second stopping element between the second stopping element and the third stopping element, the component being in the second part.

21. The process according to claim 20, wherein the first part is further merged with an additional discrete element comprising a reagent.

22. The process according to claim 20, wherein the initial discrete element comprises:
a target cell having an antigen on its surface,
an immune cell suitable to produce an antibody suitable to bind to the antigen, and
a secretome produced by the target cell and/or the immune cell;
wherein, after the splitting, the target cell and the immune cell are in the component in the second part and the secretome is in the first part and in the second part; and
wherein a reagent is an immunoassay reagent suitable to bind to some molecules of the secretome.

23. The process according to claim 15, comprising a splitting operation including the following successive steps:
blocking an initial discrete element with the first stopping element in such a way that it overlaps the second stopping element, and
closing the second stopping element in such a way that an initial discrete element is split into a first part located on one side of the second stopping element, between the first stopping element and the second stopping element, and a second part located on the other side of the second stopping element.

24. The process according to claim 23, wherein the splitting operation comprises, after the initial discrete element is blocked by the first stopping element and before the second stopping element is closed, a step of retaining, with the attractive mechanism, physically and in a releasable way, the component of the initial discrete element between the second stopping element and the third stopping element.

25. The process according to claim 15, comprising an imaging and/or tracking of the discrete element elements of the microfluidic device.

26. The process according to claim 15, comprising an unloading of the discrete element elements from the microfluidic device.

27. The process according to claim 15, wherein the discrete element comprises only one biological cell.

28. The process according to claim 15, wherein the discrete element comprises one only barcode which comprises chains of nucleotides, each chain comprising a first block identifying a corresponding chain amongst all chains in the discrete element, a second block identifying the discrete element, and a third block for attachment to a specific nucleotide sequence.
